(19) United States
(12) Patent Application Publication
(10) Pub. No.: US 2024/0324589 A1
(43) Pub. Date: Oct. 3, 2024

(54) INSECTICIDE COMPOSITION

(71) Applicant: IN2CARE HOLDING B.V., Wageningen (NL)

(72) Inventors: Anne Jurjen OSINGA, Wageningen (NL); Marit FARENHORST, Wageningen (NL); Tim Wim Ruud MÖHLMANN, Wageningen (NL)

(73) Assignee: IN2CARE HOLDING B.V., Wageningen (NL)

(21) Appl. No.: 18/708,520

(22) PCT Filed: Nov. 11, 2022
(86) PCT No.: PCT/NL2022/050643

§ 371 Date: May 8, 2024

(30) Foreign Application Priority Data
Nov. 11, 2021 (NL) 2029714

(51) Int. Cl. A01N 25/24; A01M 1/20; A01N 25/10; A01N 25/12; A01N 25/34; A01N 47/34; A01N 63/30; A01P 7/04

(52) U.S. Cl. CPC A01N 25/24; A01M 1/2016; A01N 25/10; A01N 25/12; A01N 25/34; A01N 47/34; A01N 63/30; A01P 7/04

(57) ABSTRACT

An insecticide composition including at least one insecticide powder having a melting point above: 75° C., particularly above 100° C., more particularly above 150° C., still more particularly above 200° C., and to be applied on an electrostatic substance. The insecticide composition preferably has at least one insecticide powder being a growth regulator of the benzoylurea group. The electrostatic substance includes a platinum and/or silver complex containing substance. The insecticide composition includes at least one protective powder acting against moisture, in particular silicates, zeolites, silicon dioxide, calcium carbonate and/or diatomaceous earth. The insecticide composition may also include an insect killing fungus.

The present invention relates to an insecticide composition of at least one insecticide powder, combined with an electrostatic substance. The invention also relates to a structure provided with the insecticide composition, to a pouch holding the structure and to an exterminator provided with such a structure.

Such a composition acting in an exterminator for insects and having an insecticide powder combined with an electrostatic substance layer is known from applicants' international publication WO 2014/07611 A1. This publication describes an electrostatic platinum complex-containing silicone layer provided on a dry structure and thereafter on the layer one or more insecticide powders are provided. These insecticide powders may include a juvenile hormone, such as pyriproxyfen, and/or an insect killing fungus, and/or an intensifying agent, such as a silicate. An exterminator placed outdoors attracts insects in particular mosquitoes which land on the dry structure, whereby the insecticide powders are being held by electrostatic forces exerted by the electrostatic layer. These forces are such that the mosquitoes landing thereon get powdered and thereafter die and/or that the insecticide powders are transported to their assembly or breeding places where the insecticides get spread among a large number of adults, larvae, pupae and eggs.

Try outs in various countries revealed a relatively short effective life cycle of the powdered structures. This led to high volumes of such powdered structures to be produced, transported, and stored, and led to short exchange periods of these structures in the order of two months in the field, as applied to a mosquito trap. In refrigerated storage the composition can retain its efficacy for at least two years, whereas at room temperature, here defined as 25° C., the composition can be stored for at least one year without substantial loss of efficacy.

It is an object of the present invention to provide an improved insecticide composition which is longer effective against all kinds of insects, and which is less labour intensive in practice.

Thereto the insecticide composition according to the invention comprises:
at least one insecticide powder having a melting point above 100° C., and
a substance having an electrostatic charge,
   whereby the at least one insecticide powder is a growth regulator of the benzoylurea group comprising diflubenzuron, which has a melting point above 200° C. for prolonging the effective lifecycle, storage and effectiveness of the insecticide powder.

In warmer climates erroneous storage, such as at temperatures approaching 45° C. would ordinarily lead to a coagulation of an insecticide powder. It was found that growth regulators of the benzoylurea group comprising diflubenzuron are particularly resilient against such coagulation. Efficacy is further substantially preserved under such erroneous storage conditions for compositions in which the at least one insecticide powder which has a melting point above 100° C. comprises chlorfenapyr.

The inventors found that in particular if the insecticide composition comprised pyriproxyfen as active ingredient that the long term effectiveness of the composition diminished considerably. Experiments resulted in the finding that the composition got lumpy and coagulated and that this phenomenon is linked to the melting point of pyriproxyfen, which is known to lie between 45-47° C. Experiments in developing countries showed that in particular during storage and transport the temperatures of the insecticide composition could rise to about 50-55° C. These high temperatures started the insecticide powders to coagulate to an extent that they no longer consisted of powdery particles and therefore it was no longer possible by the insects to loosen the insecticide powders from the electrostatic substance provided on an underlying structure. Gradually the coagulating particles of the insecticide powders became so clumpy that they could not be transferred and picked up by the legs of the insects during their visit to the structures, usually positioned in specially designed exterminators. Choosing the melting point of any insecticide powders in the composition at least above 75° C., particularly above 100° C., more particularly above 150° C., still more particularly above 200° C., no longer led to these negative effects.

The melting point is defined as the temperature at which crystals are in equilibrium with the liquid phase at atmospheric pressure. It is known that there are methods to relate the melting point to the boiling point. So, using these methods the melting points referred to herein can be expressed in terms of boiling points as well.

The insecticide composition is intended to be used in a combination of the particular insecticide powder and the electrostatic substance, such that before use the insecticide powder is applied on the electrostatic substance to result in the insecticide composition according to the invention. This combination results in a wanted promotion of the sticking of the insecticide onto some structure, as well as in the wanted transport of the insecticide powder by an insect from the structure to their breeding or resting places.

Applicable insecticide powders in the composition according to the invention having a melting point above specific values are as follows:
above 75° C. comprising: indoxacarb (melting point 88.1° C.), and/or tolfenpyrad (melting point 87.0-89.0° C.) and/or oxadiazine (melting point 88.0-90.0° C.); and/or
above 100° C. comprising: chlorfenapyr (melting point 100.0-101.0° C.), and/or spinetoram (melting point 143.4° C.), and/or dinotefuran (melting point 107.5° C.), and/or neonicotnoid (melting point 107.5° C.), and/or sulfoximines (melting point 107.5° C.), and/or sulfoxaflor (melting point 112.9° C.), and/or oxazosulfyl (melting point 138.2-140.1° C.), and/or fenpyroximate (melting point 102.0° C.); and/or
above 150° C. comprising: abamectin (melting point 161.8° C.), and/or meta-diamide (melting point 154-155.5° C.), and/or semicarbazone (melting point 184-187° C.), and/or clothianidin point 176.8° C.), and/or (melting broflanilide (melting point 154.0-155.5° C.), and/or metaflumizone (melting point 184.0-187.0° C.) and/or triflumezopyrim (melting point 189.1-189.4).

Preferred as the at least one insecticide powder in the composition according to the invention is a growth regulator of the benzoylurea group. Benzoylureas are chemical derivatives of N-benzoyl-N′-phenylurea, which are known to act as insect growth regulators by inhibiting synthesis of chitin in the insect's body.

Members of this group having a melting point above specific values mentioned here are as follows:
above 150° C. comprising: flufenoxuron (melting point 169-172° C.), and/or triflumuron (melting point 195° C.), also known as Alsystin®; and/or
above 200° C. comprising: diflubenzuron (melting point 228° C.), and/or chlorfluazuron, and/or novaluron, and/or hexaflumuron (melting point 203-204° C.).

In an embodiment of the composition according to the invention the electrostatic substance comprises a platinum and/or silver complex containing substance. Details of in particular the most preferred platinum complex containing silicone composition can be found in WO 2014/007611 and further details thereof can be found in WO 2009/048324. Both publications are here included by reference thereto.

Preferably the insecticide powder in the composition according to the invention has an average particle size between 2 and 20 μm. Insecticide powder particles smaller than approximately 2 μm prove more difficult to transfer from a structure having the electrostatic substance with thereon the insecticide powder(s) to the insects, whereas particles larger than 20 μm do not electrostatically stick easily to the legs of the insects and get more easily lost during the flight back to their breeding or resting places.

In a further embodiment the insecticide composition according to the invention comprises at least one protective powder acting against moisture, in particular silicates-which also works as an intensifying agent-zeolites, silicon dioxide, calcium carbonate and/or diatomaceous earth. The action of the protective powder is twofold in that it prevents the possibly hygroscopic insecticides from attracting moisture and in that it promotes an extra drying out of the skin of the insects put in contact with the powder.

Preferably the protective powder has an average particle size between 0.1 and 5 μm, in order to safeguard an optimal efficient protective action of the powder.

If combined with an insect killing fungus, such as fungi of the genera Beauveria and/or Metarhizium and/or Isaria and/or Lagenidium and/or Coelomomyces and/or Culicinomyces and/or Entomophaga and/or Nomuraea, the protective powder prolongs the action of the fungus in the composition according to the invention due to the fact that the fungus is kept dry by the protective powder during a longer period of time.

It was found that, also separately from the above, that a combination of the benzoylurea group comprising diflubenzuron, and the at least one insecticide powder which having a melting point above 100° C. comprising chlorfenapyr, such as exclusively comprising chlorfenapyr, can beneficially render the composition less prone clumping when in close proximity to water. This, in turn, allows the substance to be used for longer periods of time in close proximity to mosquito breeding places, thereby increasing its efficacy.

At present the application of the insecticide composition in particular onto a possible structure, and an exterminator as well as a pouch for holding said structure according to the invention will be elucidated further, together with their additional advantages, while reference is being made to the appended drawings, wherein similar components are being referred to by means of the same reference numerals.

In the drawings:

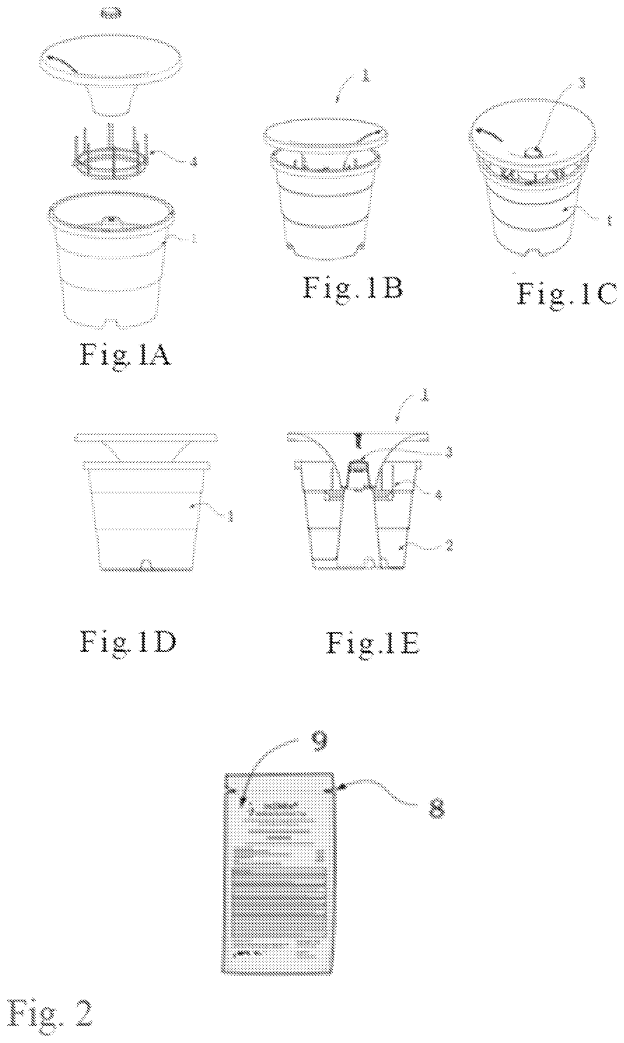

FIGS. 1A-1E show perspective views and a sectional view respectively of an exterminator to be provided with a structure according to the invention whereon the insecticide composition according to the invention is provided;

FIG. 2 shows a pouch according to the invention for holding the structure of FIGS. 1A-1E; and

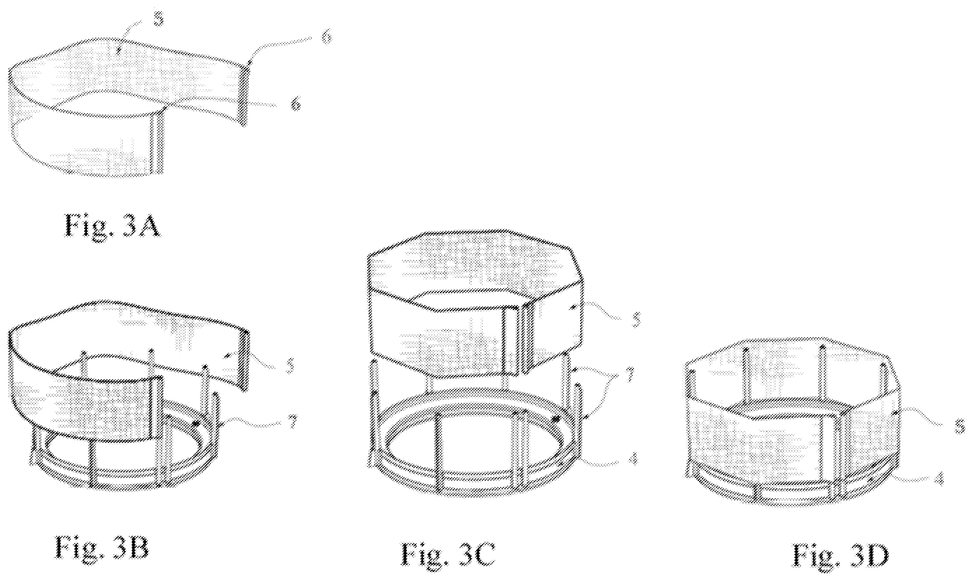

FIGS. 3A-3D show views of a possible embodiment of a structure according to the invention for applying the insecticide composition thereon.

FIGS. 1A-1E show views of a possible embodiment of an exterminator 1 of a type largely similar to an exterminator outlined in WO 2014/007611. In the exterminator 1 an amount of water is present in a largely donut shaped water container 2 present around a central shaft 3 where along a float body 4 is axially movable while floating on the water. A structure 5 is fitted on the float body 4 as shown in FIGS. 3A-3E, while the structure 5 is provided with the insecticide composition outlined hereinbefore. The structure 5 as shown here has the form of a gauze, net, cloth, screen, grid, fabric or some other mesh structure having tube ends 6 to be fitted on piles 7 on the float body 4. In other possible embodiments the structure 5 has the form of a wall and/or ceiling, and/or the structure 5 is made out of concrete, stone, plaster, wood, paper, carton and/or a plastic, whereby on the structure 5 the electrostatic substance is provided whereon the insecticide powder is provided. In general the structure 5 is made of a plastic and/or is such non conductive that it is capable of holding an electric charge of the electrostatic substance mentioned hereinbefore. The plastic may comprise polyester, polystyrene and/or polyethylene.

FIG. 2 shows a pouch 8 which preferably is provided with an electric conducting foil material 9 for in particular electrically shielding the electrostatic substance and the structure 5 packaged therein. In general the material 7 will comprise a metal.

1. An insecticide composition comprising:
at least one insecticide powder having a melting point above 100° C., and
a substance having an electrostatic charge,
whereby the at least one insecticide powder is a growth regulator of the benzoylurea group, the insecticide powder having an average particle size between 2 and 20 μm, for prolonging the effective lifecycle, storage and effectiveness of the insecticide powder.

2. The insecticide composition according to claim 1, wherein the at least one insecticide powder is selected from flufenoxuron (melting point 169-172° C.), and/or triflumuron (melting point 195° C.) and/or diflubenzuron (melting point 228° C.), and/or chlorfluazuron (melting point above 200° C.), and/or novaluron (melting point above 200° C.), and/or hexaflumuron (melting point 203-204° C.).

3. The insecticide composition according to claim 1, wherein the insecticide powder is diflubenzuron.

4. The insecticide composition according to claim 1, wherein the substance having the electrostatic charge comprises a platinum and/or silver complex containing substance.

5. The insecticide composition according to claim 1, wherein in addition the insecticide composition comprises an insect killing fungus, such as fungi of the genera Beauveria and/or Metarhizium and/or Isaria and/or Lagenidium and/or Coelomomyces and/or Culicinomyces and/or Entomophage and/or Nomuraea.

6. The insecticide composition according to claim 1, wherein the insecticide composition comprises at least one protective powder acting against moisture.

7. The insecticide composition according to claim 6, wherein the protective powder has an average particle size between 0.1 and 5 μm.

8. A structure provided with the insecticide composition according to claim 1, wherein the structure has the form of a gauze, net, cloth, screen, grid, fabric, wall and/or ceiling and/or is made out of concrete, stone, plaster, wood, paper, carton and/or a plastic, whereby on the structure the substance having the electrostatic charge is provided whereon the insecticide powder is provided.

9. The structure according to claim 8, wherein the structure has the form of a gauze, net, cloth, screen, grid, or fabric.

10. The structure according to claim 9, whereby the structure which is made of the plastic is such non conductive that it is capable of holding the electric charge of the substance having the electrostatic charge.

11. The structure according to claim 10, wherein the plastic comprises polyester, polystyrene and/or polyethylene.

12. A pouch holding the structure according to claim 8, wherein the pouch is provided with an electric conducting foil material embodied to electrically shield the structure packaged therein.

13. An exterminator for mosquitos comprising a structure according to claim 8.

14. The exterminator according to claim 13, which comprises a structure in the form of a gauze, net, cloth, screen, grid, or fabric, which is provided with an insecticide powder which is diflubenzuron, in combination with a protective powder acting against moisture, selected from the group of silicates, zeolites, silicon dioxide, calcium carbonate and/or diatomaceous earth, the protective powder having an average particle size between 0.1 and 5 μm.
